(19) United States
(12) Patent Application Publication
(10) Pub. No.: US 2016/0147048 A1
(43) Pub. Date: May 26, 2016

(54) ZOOM LENS AND IMAGE PICKUP APPARATUS INCLUDING THE SAME

(71) Applicant: CANON KABUSHIKI KAISHA, Tokyo (JP)

(72) Inventors: Masatsugu Nakano, Utsunomiya-shi (JP); Kazuhiko Kajiyama, Utsunomiya-shi (JP); Takeyoshi Saiga, Tokyo (JP)

(21) Appl. No.: 14/942,003

(22) Filed: Nov. 16, 2015

(30) Foreign Application Priority Data
Nov. 25, 2014 (JP) 2014-237550

(51) Int. Cl. G02B 15/173; G02B 13/14; G02B 15/16

(52) U.S. Cl. CPC G02B 15/173; G02B 15/16; G02B 13/146

(57) ABSTRACT

Provided is a zoom lens, comprising, in order from an object side to an image side: a first lens unit having a positive refractive power; a second lens unit having a negative refractive power; and a third lens unit having a positive refractive power. The second lens unit is configured to move toward the image side during zooming from a wide angle end to a telephoto end, and an interval between adjacent lens units is changed during zooming. The first lens unit includes a positive lens and a negative lens that are arranged adjacent to each other. Materials for the positive lens and the negative lens are appropriately set.

### BACKGROUND OF THE INVENTION

1. Field of the Invention

The present invention relates to a zoom lens, and more particularly, to a zoom lens suitable as an image pickup optical system to be used in an image pickup apparatus, such as a monitoring camera, a digital camera, a video camera, and a broadcasting camera.

2. Description of the Related Art

In recent years, as an image pickup optical system to be used in an image pickup apparatus, a zoom lens is required to have a high zoom ratio and a small overall system size. For example, as an image pickup optical system for a monitoring camera, a zoom lens is required to have a small overall system size and a high zoom ratio, and is also required that favorable optical characteristics can be obtained in imaging during daytime and at night.

In general, a monitoring camera uses visible light in imaging during daytime, and uses near-infrared light in imaging at night. The use of near-infrared light provides an advantage in that imaging can be carried out with less influence of scattering than when visible light is used, for example, in a dense fog with low visibility. Thus, it is demanded that a zoom lens used in a monitoring camera be corrected for an aberration in a broad wavelength range from a visible range to a near-infrared range. Hitherto, there is known a zoom lens having a high zoom ratio, which is corrected for various aberrations across a visible range to a near-infrared range.

In Japanese Patent Application Laid-Open No. 2011-053526, there is disclosed a zoom lens having a zoom ratio of 18.79. This zoom lens includes, in order from an object side to an image side, first to fourth lens units having positive, negative, positive, and positive refractive powers, and an interval between adjacent lens units is changed during zooming.

In Japanese Patent Application Laid-Open No. 2013-88782, there is disclosed a zoom lens having a zoom ratio of 2.44. This zoom lens includes, in order from an object side to an image side, first to third lens units having positive, negative, and positive refractive powers, and an interval between adjacent lens units is changed during zooming.

In Japanese Patent Application Laid-Open No. 2013-171207, there is disclosed a zoom lens having a zoom ratio of 5.92. This zoom lens includes, in order from an object side to an image side, first to fifth lens units having positive, negative, positive, positive, and positive refractive powers, and an interval between adjacent lens units is changed during zooming.

In the zoom lens for a monitoring camera, near-infrared light is used in most cases in imaging at night. However, there are cases where a sufficient amount of light cannot be obtained from the near-infrared light, for example, when there is very little moon light around the time of a new moon and when the moon is hidden by a cloud. Light called nightglow (peak wavelength of 1.6 μm) is emitted when hydroxide ions in an atmosphere are excited by the sunlight. With the use of this light, favorable imaging can be achieved with ease even when there is little moonlight.

In the zoom lens for a monitoring camera, in order to obtain favorable optical characteristics over a broad wavelength range from a visible range to a near-infrared range while achieving a higher zoom ratio, it is important to appropriately set the zoom type and the lens configuration of each lens unit. For example, in a zoom lens that includes three or more lens units including, in order from the object side to the image side, first to third lens units having positive, negative, and positive refractive powers, it is important to appropriately set materials for the lenses configuring the first lens unit or the lenses configuring the second lens unit.

In the zoom lens disclosed in Japanese Patent Application Laid-Open No. 2011-053526, the zoom ratio is high, but the aberrations are not sufficiently corrected up to the near-infrared range of a wavelength of 1.6 μm. In the zoom lenses disclosed in Japanese Patent Application Laid-Open Nos. 2013-88782 and 2013-171207, the axial aberration is favorably corrected from the visible range to the near-infrared range, but the zoom ratio is not sufficiently high.

### SUMMARY OF THE INVENTION

According to one embodiment of the present invention, there is provided a zoom lens, comprising, in order from an object side to an image side:

a first lens unit having a positive refractive power;

a second lens unit having a negative refractive power; and

a third lens unit having a positive refractive power,

in which the second lens unit is configured to move toward the image side during zooming from a wide angle end to a telephoto end, and an interval between adjacent lens units is changed during zooming,

in which the first lens unit comprises a positive lens (LP1) and a negative lens (LN1) that are arranged adjacent to each other, and

in which the following conditional expression is satisfied:

−0.003<(θIRP1−θIRN1)/(νIRP1−νIRN1)<0.003

where, when a refractive index of a lens material at a wavelength of 400 nm is Ns, a refractive index of a lens material at a wavelength of 1,050 nm is Nm, a refractive index of a lens material at a wavelength of 1,700 nm is Nl, and an Abbe number νIR of a lens material and a partial dispersion ratio θIR of a lens material are νIR=(Nm−1)/(Ns−N1) and θIR=(Ns−Nm)/(Ns−Nl), respectively, νIRP1 and θIRP1 represent an Abbe number and a partial dispersion ratio of a material for the positive lens (LP1), respectively, and νIRN1 and θIRN1 represent an Abbe number and a partial dispersion ratio of a material for the negative lens (LN1), respectively.

In addition, according to one embodiment of the present invention, there is provided a zoom lens, comprising, in order from an object side to an image side:

a first lens unit having a positive refractive power;

a second lens unit having a negative refractive power; and

a third lens unit having a positive refractive power,

in which the second lens unit is configured to move toward the image side during zooming from a wide angle end to a telephoto end, and an interval between adjacent lens units is changed during zooming,

in which the following conditional expression is satisfied:

−0.005<(F1L−F1M)/F1M<0.005

where F1M represents a focal length of the first lens unit at a wavelength of 1,050 nm, and F1L represents a focal length of the first lens unit at a wavelength of 1,700 nm.

Further features of the present invention will become apparent from the following description of exemplary embodiments with reference to the attached drawings.

### BRIEF DESCRIPTION OF THE DRAWINGS

FIG. 1 is a lens cross-sectional view of a zoom lens at a wide angle end according to Example 1 of the present invention.

FIG. 2A is a diagram for showing aberrations at the wide angle end of the zoom lens of Example 1.

FIG. 2B is a diagram for showing aberrations at a telephoto end of the zoom lens of Example 1.

FIG. 3 is a lens cross-sectional view of a zoom lens at a wide angle end according to Example 2 of the present invention.

FIG. 4A is a diagram for showing aberrations at the wide angle end of the zoom lens of Example 2.

FIG. 4B is a diagram for showing aberrations at a telephoto end of the zoom lens of Example 2.

FIG. 5 is a lens cross-sectional view of a zoom lens at a wide angle end according to Example 3 of the present invention.

FIG. 6A is a diagram for showing aberrations at the wide angle end of the zoom lens of Example 3.

FIG. 6B is a diagram for showing aberrations at a telephoto end of the zoom lens of Example 3.

FIG. 7 is a lens cross-sectional view of a zoom lens at a wide angle end according to Example 4 of the present invention.

FIG. 8A is a diagram for showing aberrations at the wide angle end of the zoom lens of Example 4.

FIG. 8B is a diagram for showing aberrations at a telephoto end of the zoom lens of Example 4.

FIG. 9 is a schematic view of a main part of a monitoring camera (image pickup apparatus) according to the present invention.

### DESCRIPTION OF THE EMBODIMENTS

Preferred embodiments of the present invention will now be described in detail in accordance with the accompanying drawings.

Now, a zoom lens and an image pickup apparatus including the same of the present invention are described. The zoom lens of the present invention includes, in order from an object side to an image side, a first lens unit having a positive refractive power, a second lens unit having a negative refractive power, and a third lens unit having a positive refractive power. The second lens unit is configured to move toward the image side during zooming from a wide angle end to a telephoto end. In addition, an interval between adjacent lens units is changed during zooming.

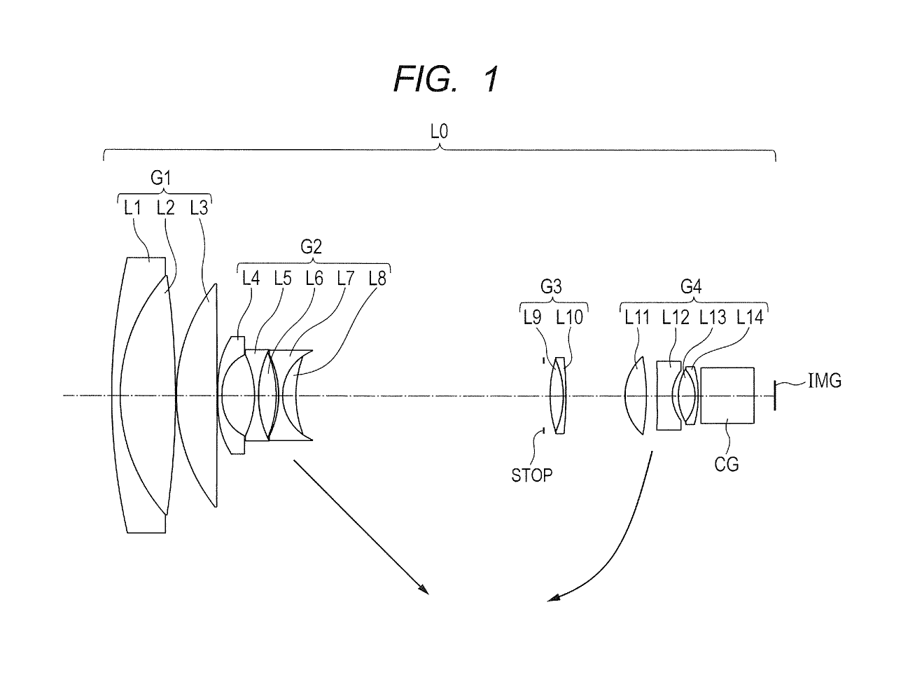

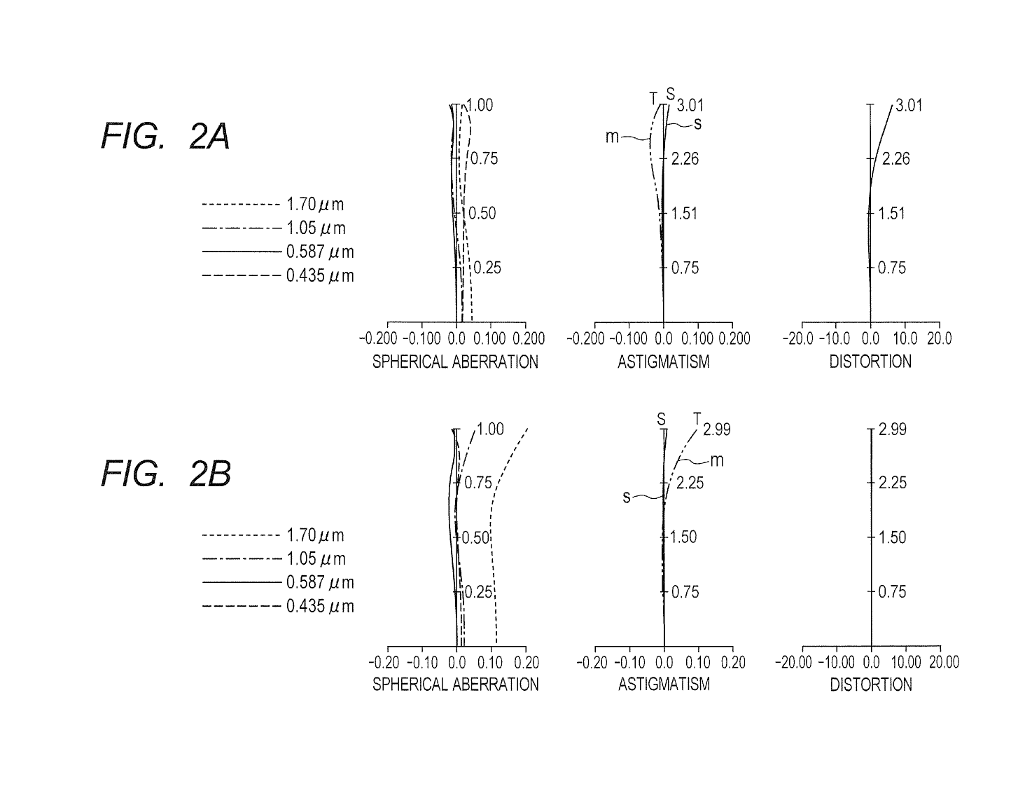

FIG. 1 is a lens cross-sectional view at the wide angle end (short focal length end) of a zoom lens according to Example 1 of the present invention. FIGS. 2A and 2B are aberration diagrams at the wide angle end and the telephoto end (long focal length end), respectively, of the zoom lens of Example 1. The optical magnification of the zoom lens of Example 1 is 19.79 (zoom ratio of 19.79), and a wavelength range in which the zoom lens is corrected for aberrations is from 400 nm to 1,700 nm.

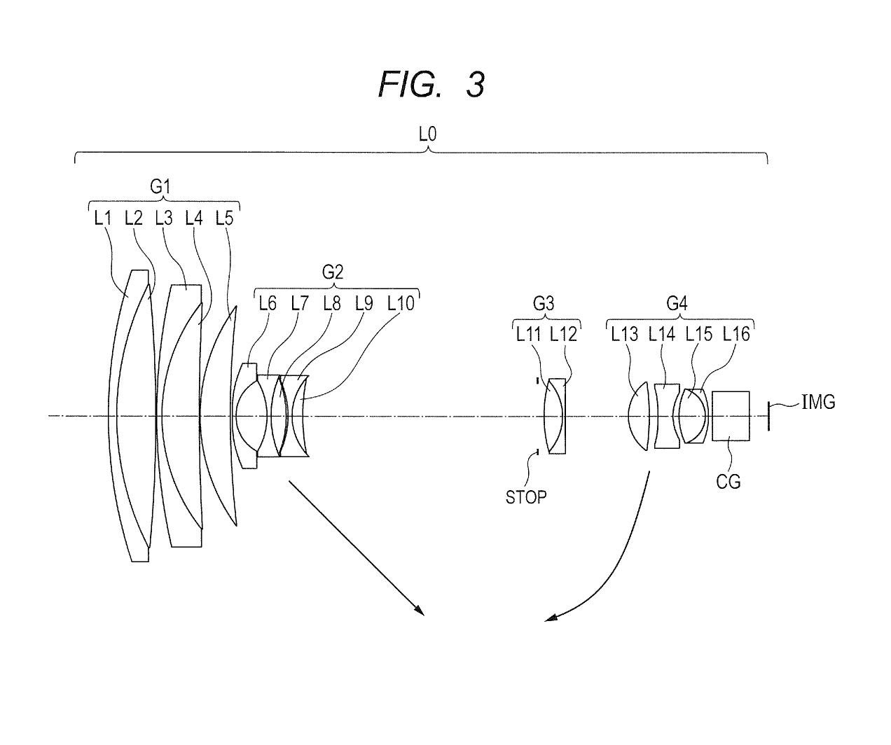

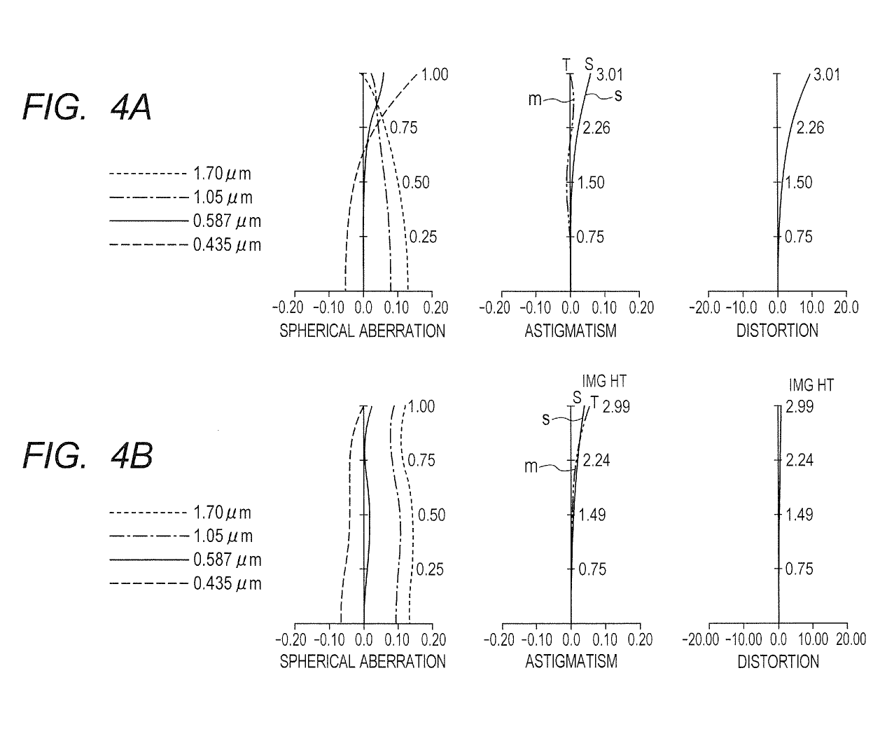

FIG. 3 is a lens cross-sectional view at the wide angle end of a zoom lens according to Example 2 of the present invention. FIGS. 4A and 4B are aberration diagrams at the wide angle end and the telephoto end, respectively, of the zoom lens of Example 2. The optical magnification of the zoom lens of Example 2 is 19.80, and a wavelength range in which the zoom lens is corrected for aberrations is from 400 nm to 1,700 nm.

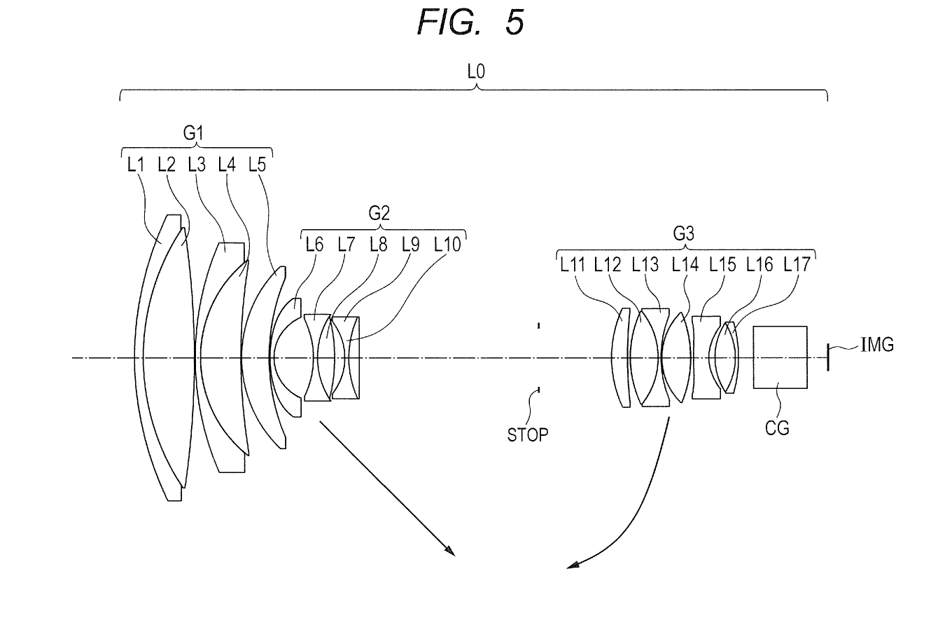

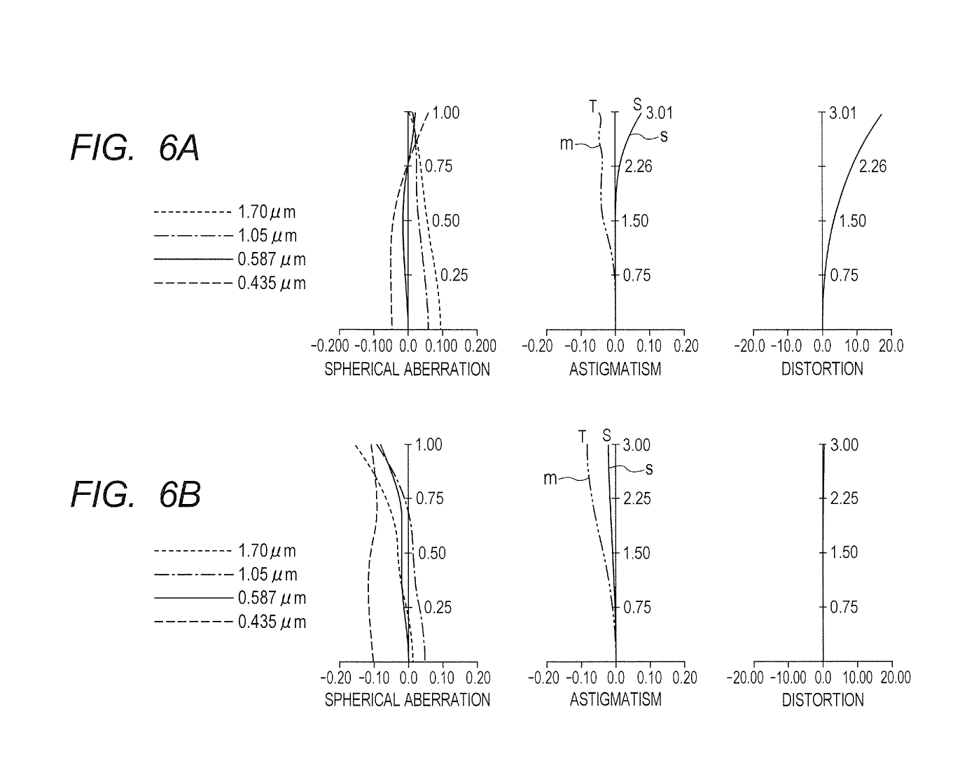

FIG. 5 is a lens cross-sectional view at the wide angle end of a zoom lens according to Example 3 of the present invention. FIGS. 6A and 6B are aberration diagrams at the wide angle end and the telephoto end, respectively, of the zoom lens of Example 3. The optical magnification of the zoom lens of Example 3 is 14.62, and a wavelength range in which the zoom lens is corrected for aberrations is from 400 nm to 1,700 nm.

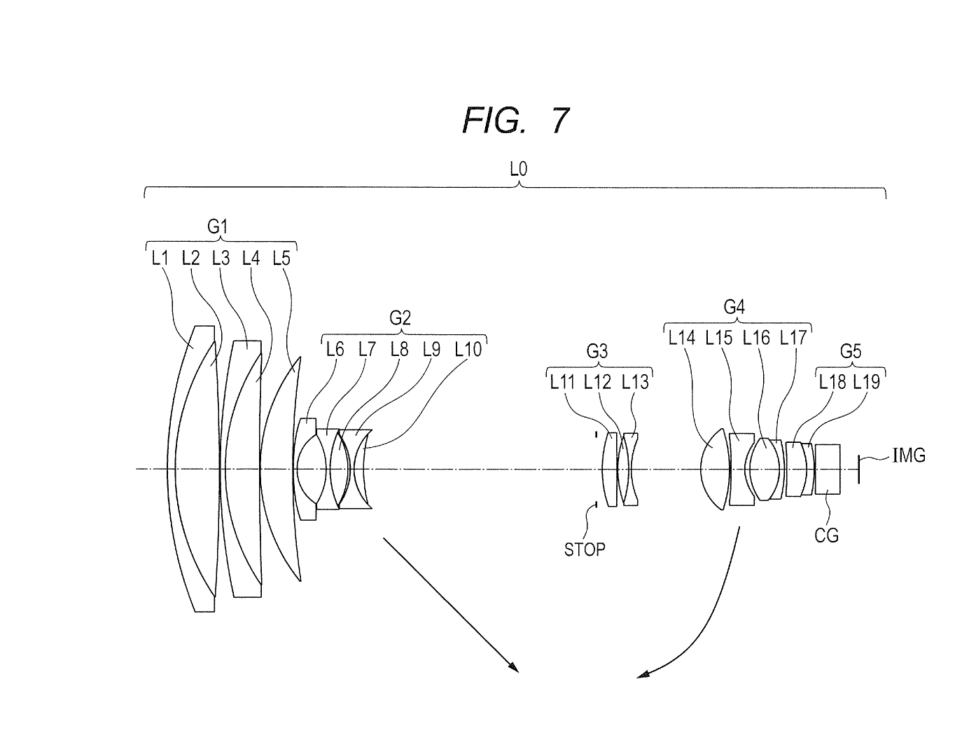

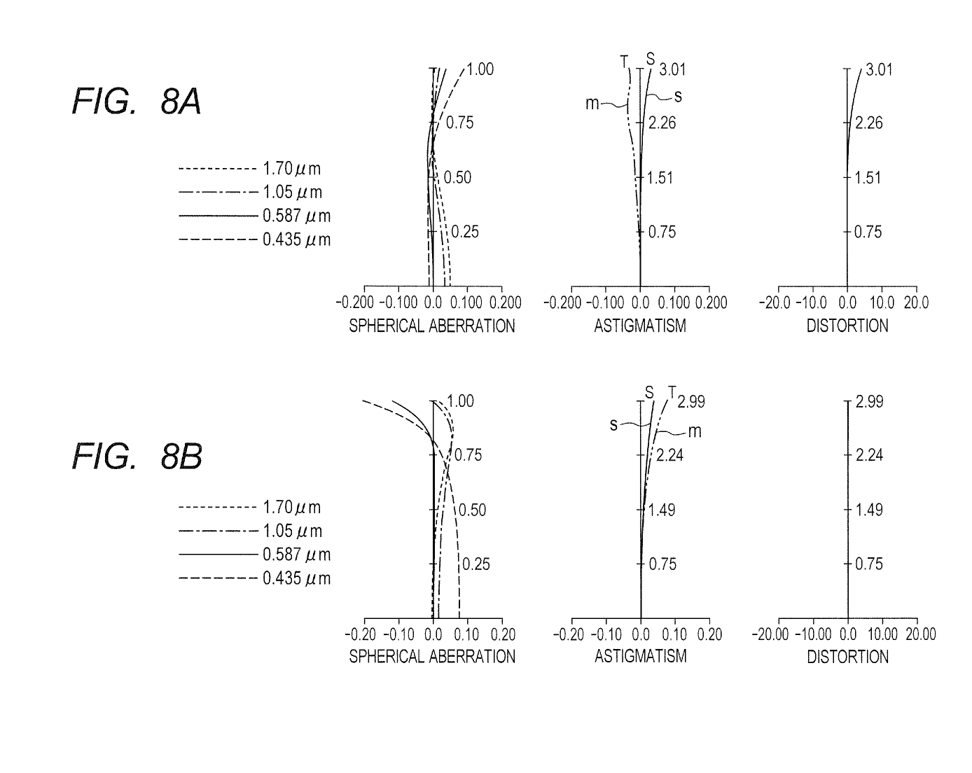

FIG. 7 is a lens cross-sectional view at the wide angle end of a zoom lens according to Example 4 of the present invention. FIGS. 8A and 8B are aberration diagrams at the wide angle end and the telephoto end, respectively, of the zoom lens of Example 4. The optical magnification of the zoom lens of Example 4 is 25.00, and a wavelength range in which the zoom lens is corrected for aberrations is from 400 nm to 1,700 nm.

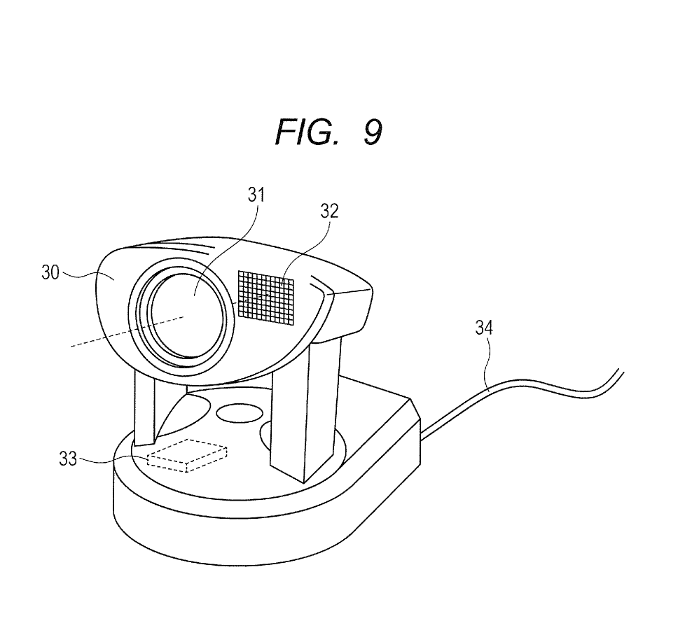

FIG. 9 is a schematic view of a main part of the image pickup apparatus according to the present invention. The zoom lens according to each of the examples is used in the image pickup apparatus. In the lens cross-sectional views, the left side corresponds to the object side (front side), and the right side corresponds to the image side (rear side). A zoom lens LO is illustrated in the lens cross-sectional views. A first lens unit G1 has a positive refractive power, a second lens unit G2 has a negative refractive power, a third lens unit G3 has a positive refractive power, a fourth lens unit G4 has a positive refractive power, and a fifth lens unit G5 has a positive refractive power.

An F number determination member (hereinafter referred to also as “aperture stop”) STOP has a function of aperture stop for determining (limiting) a maximum F number (Fno) light flux. An optical block CG corresponds to an optical filter, a face plate, a crystal low pass filter, an infrared cut filter, or the like.

As an image plane IMG, an image pickup surface of a solid-state image pickup element (photo-electric conversion element) such as a CCD sensor and a CMOS sensor is arranged when the zoom lens is used as an image pickup optical system of a video camera and a digital still camera. The arrows indicate movement loci of the respective lens units during zooming from the wide angle end to the telephoto end. In each of the examples, focusing from infinity to a near field is carried out by feeding out the first lens unit G1 toward the object side.

An aberration diagram is shown in units of millimeters, and in a spherical aberration diagram, aberrations at a wavelength of 1,700 nm, (1.70 μm), a wavelength of 1,050 nm (1.05 μm), a wavelength of 587 nm (0.587 μm) (d-line), and a wavelength of 435 nm (0.435 μm) (g-line) are indicated. In an astigmatism diagram, symbol m represents a meridional image plane of the d-line, and symbol s represents a sagittal image plane of the d-line. Note that, in the following examples, the wide angle end and the telephoto end refer to zoom positions obtained when a lens unit for varying the magnification (second lens unit G2) is located at respective ends of a range on a mechanism in which the stated lens unit can move along an optical axis. Unless otherwise indicated, the description is herein based on a premise that the lens structures are arranged in order from the object side to the image side.

The zoom lens according to the present invention includes, in order from the object side to the image side: the first lens unit G1 having a positive refractive power; the second lens unit G2 having a negative refractive power; and the third lens unit G3 having a positive refractive power. The second lens unit G2 is configured to move from the object side toward the image side along the optical axis during zooming from the wide angle end to the telephoto end.

The first lens unit G1 includes a lens pair LB1 of a positive lens LP1 and a negative lens LN1 that are arranged adjacent to each other. A refractive index of a material at a wavelength of 400 nm is Ns, a refractive index of a material at a wavelength of 1,050 nm is Nm, a refractive index of a material at a wavelength of 1,700 nm is Nl, and an Abbe number νIR of a material and a partial dispersion ratio θIR of a material are νIR=(Nm−1)/(Ns−Nl) and θIR=(Ns−Nm)/(Ns−Nl), respectively.

An Abbe number and a partial dispersion ratio of a material for the positive lens LP1 are represented by νIRP1 and θIRP1, respectively, and an Abbe number and a partial dispersion ratio of a material for the negative lens LN1 are represented by νIRN1 and θIRN1, respectively. At this time, the following conditional expression is satisfied.

−0.003<(θIRP1−θIRN1)/(νIRP1−νIRN1)<0.003 (1)

Conditional Expression (1) represents an index for estimating the amount of axial chromatic aberration (secondary spectrum) at a wavelength of 1,050 nm, which is generated when the axial chromatic aberrations at a wavelength of 400 nm and a wavelength of 1,700 nm are corrected by the lens pair LB1 of the positive lens LP1 and the negative lens LN1. In a combination of the positive lens LP1 and the negative lens LN1, the amount of secondary spectrum becomes smaller as the index becomes smaller. Accordingly, when the range of Conditional Expression (1) is satisfied, the secondary spectrum of the axial chromatic aberration can be reduced, and the axial chromatic aberration can be corrected favorably across a broad wavelength range from a visible range to a near-infrared range.

When the ratio falls below the lower limit or exceeds the upper limit of Conditional Expression (1), the secondary spectrum of the axial chromatic aberration is generated in a large amount at the telephoto end by the first lens unit G1, and the imaging performance deteriorates. In addition, in the zoom lens of the present invention, it is preferred that the Abbe numbers of all the positive lenses included in the first lens unit satisfy the following conditional expression.

In each of the examples, it is more preferred to satisfy at least one of the following conditional expressions. An Abbe number of a material for the positive lens included in the first lens unit G1 is represented by νIRP1a. The second lens unit G2 includes a lens pair LB2 of a positive lens LP2 and a negative lens LN2 that are arranged adjacent to each other. An Abbe number and a partial dispersion ratio of a material for the positive lens LP2 are represented by νIRP2 and θIRP2, respectively, and an Abbe number and a partial dispersion ratio of a material for the negative lens LN2 are represented by νIRN2 and θIRN2, respectively.

A focal length of the first lens unit G1 at a wavelength of 1,050 nm is represented by F1M. A focal length of the first lens unit G1 at a wavelength of 1,700 nm is represented by F1L. A focal length of the zoom lens at a wavelength of 1,050 nm at the telephoto end is represented by FTM. At this time, it is preferred to satisfy at least one of the following conditional expressions.

18.0<νIRP1a (2)

−0.005<(θIRP2−θIRN2)/(νIRP2−νIRN2)<0.005 (3)

−0.005<(F1L−F1M)/F1M<0.005 (4)

0.50<F1M/FTM<1.00 (5)

Next, the technical meanings of each of the conditional expressions described above are described. Conditional Expression (2) relates to the Abbe number of the material for all the positive lenses included in the first lens unit G1. When the value falls below the lower limit of Conditional Expression (2), the refractive powers of the materials for the positive lenses and the negative lenses included in the first lens unit G1 are increased, and high-order aberrations are generated in a large amount. Further, the axial chromatic aberration is generated in a large amount at the telephoto end by the first lens unit G1, and it becomes difficult to correct this aberration.

Conditional Expression (3) relates to the material for each lens in the lens pair LB2, which is included in the second lens unit G2 and is made up of the positive lens LP2 and the negative lens LN2 that are adjacent to each other. When the ratio falls below the lower limit or exceeds the upper limit of Conditional Expression (3), the axial chromatic aberration is generated in a large amount by the second lens unit G2, and a fluctuation of chromatic aberration during zooming increases. Thus, it becomes difficult to achieve a higher zoom ratio.

Conditional Expression (4) relates to the focal length of the first lens unit G1 at a wavelength of 1,050 nm and to the focal length of the first lens unit G1 at a wavelength of 1,700 nm, and is satisfied to favorably correct the axial chromatic aberration at the telephoto end across a broad wavelength range from a visible range to a near-infrared range. Conditional Expression (4) is an index for estimating the amount of axial chromatic aberration in a near-infrared range generated by the first lens unit G1. When the ratio falls below the lower limit or exceeds the upper limit of Conditional Expression (4), the secondary spectrum of the axial chromatic aberration is generated in a large amount at the telephoto end by the first lens unit G1, and the imaging performance deteriorates.

Conditional Expression (5) relates to the ratio of the focal length of the first lens unit G1 at a wavelength of 1,050 nm to the focal length of the zoom lens at the telephoto end at a wavelength of 1,050 nm. When the ratio falls below the lower limit of Conditional Expression (5) so that the focal length of the first lens unit G1 becomes too short, it becomes difficult to correct various aberrations. In addition, when the ratio exceeds the upper limit of Conditional Expression (5) so that the focal length of the first lens unit G1 becomes too long, the total lens length becomes too long, and it becomes difficult to reduce the size of the zoom lens.

As described above, according to the present invention, a zoom lens that is favorably corrected for various aberrations across a broad wavelength range from a visible range to a near-infrared range is obtained. In each of the examples, it is more preferred to set the numerical ranges of Conditional Expressions (1) to (5) as follows.

−0.002<(θIRP1−θIRN1)/(νIRP1−νIRN1)<0.002 (1a)

20.0<νIRP1a (2a)

−0.0048<(θIRP2−θIRN2)/(νIRP2−νIRN2)<0.0050 (3a)

'10.002<(F1L−F1M)/F1M<0.003 (4a)

0.60<F1M/FTM<0.80 (5a)

In the zoom lens according to the present invention, when the lens pair of the positive lens and the negative lens that are adjacent to each other is formed of a cemented lens, it becomes even easier to favorably correct the chromatic aberration. In addition, an anti-reflection film for a broad wavelength range with a large number of layers becomes unnecessary. For example, it is preferred that the lens pair LB1 be formed of a cemented lens. In addition, it is preferred that the lens pair LB2 be formed of a cemented lens. The lens pair LB2 is formed of a cemented lens formed by cementing the positive lens LP2 and the negative lens LN2. In each of the examples, two lens pairs LB2 are included.

The zoom lens of Examples 1 and 2 includes, in order from the object side to the image side, the first lens unit having a positive refractive power, the second lens unit having a negative refractive power, the third lens unit having a positive refractive power, and the fourth lens unit having a positive refractive power. In addition, the second lens unit is configured to move toward the image side during zooming from the wide angle end to the telephoto end, and the fourth lens unit is configured to move toward the object side during the zooming.

The zoom lens of Example 3 includes, in order from the object side to the image side, the first lens unit having a positive refractive power, the second lens unit having a negative refractive power, and the third lens unit having a positive refractive power. In addition, the second lens unit is configured to move toward the image side during zooming from the wide angle end to the telephoto end, and the third lens unit is configured to move toward the object side during the zooming.

The zoom lens of Example 4 includes, in order from the object side to the image side, the first lens unit having a positive refractive power, the second lens unit having a negative refractive power, the third lens unit having a positive refractive power, the fourth lens unit having a positive refractive power, and the fifth lens unit having a positive refractive power. In addition, the second lens unit is configured to move toward the image side during zooming from the wide angle end to the telephoto end, and the fourth lens unit is configured to move toward the object side during the zooming.

In each of the examples, the above-mentioned configuration is employed to achieve a higher zoom ratio while reducing the size of the zoom lens.

As described above, according to the present invention, a zoom lens having high optical characteristics, which is reduced in various aberrations across a broad wavelength range from a visible range to a near-infrared range, is obtained.

In addition, another zoom lens of the present invention comprises, in order from the object side to the image side: a first lens unit having a positive refractive power; a second lens unit having a negative refractive power; and a third lens unit having a positive refractive power. The second lens unit is configured to move toward the image side during zooming from the wide angle end to the telephoto end, and an interval between adjacent lens units is changed during zooming. The another zoom lens of the present invention has a feature of satisfying Conditional Expression (4). When Conditional Expression (4) is satisfied under the above-mentioned configuration, the secondary spectrum of the axial chromatic aberration at the telephoto end can be favorably corrected as described above.

Next, the lens structure of the zoom lens in each of the examples is described.

### EXAMPLE 1

The structure of the zoom lens of Example 1 is described. The zoom lens of Example 1 includes the first lens unit G1 having a positive refractive power, the second lens unit G2 having a negative refractive power, the aperture stop STOP that determines a predetermined aperture, the third lens unit G3 having a positive refractive power, and the fourth lens unit G4 having a positive refractive power. The optical block CG is arranged between the fourth lens unit G4 and the image plane IMG. If this optical block CG is not necessary, the optical block CG can be omitted. In the following, an i-th lens counted in order from the object side to the image side is represented by Li.

The first lens unit G1 includes a lens L1 having a negative refractive power (hereinafter referred to as “negative lens”), a lens L2 having a positive refractive power (hereinafter referred to as “positive lens”), and a lens L3 having a positive refractive power, and the negative lens L1 and the positive lens L2 are cemented. The second lens unit G2 includes a negative lens L4, a negative lens L5, a positive lens L6, a negative lens L7, and a positive lens L8. The negative lens L5 and the positive lens L6 are cemented, and the negative lens L7 and the positive lens L8 are cemented. Aspherical surfaces are used for both surfaces of the negative lens L4.

The third lens unit G3 includes a positive lens L9 and a negative lens L10. The positive lens L9 and the negative lens L10 are cemented. The fourth lens unit G4 includes a positive lens L11, a negative lens L12, a positive lens L13, and a negative lens L14. The positive lens L13 and the negative lens L14 are cemented. Aspherical surfaces are used for both surfaces of the negative lens L12.

During zooming, the second lens unit G2 and the fourth lens unit G4 are configured to move in an optical axis direction. Specifically, when the second lens unit G2 is moved along the optical axis, the magnification is varied, and a variation in the image plane associated therewith is corrected by moving the fourth lens unit G4. The lenses and the values corresponding to the respective conditional expressions are as indicated in Table 1.

### EXAMPLE 2

The structure of the zoom lens of Example 2 is described. Example 2 is the same as Example 1 in signs of the refractive powers of the respective lens units, movement of the respective lens units during zooming, and the like.

The first lens unit G1 includes a negative lens L1, a positive lens L2, a negative lens L3, a positive lens L4, and a positive lens L5. The negative lens L1 and the positive lens L2 are cemented, and the negative lens L3 and the positive lens L4 are cemented. The second lens unit G2 includes a negative lens L6, a negative lens L7, a positive lens L8, a negative lens L9, and a positive lens L10. The negative lens L7 and the positive lens L8 are cemented, and the negative lens L9 and the positive lens L10 are cemented. Aspherical surfaces are used for both surfaces of the negative lens L6.

The third lens unit G3 includes a positive lens L11 and a negative lens L12. The positive lens L11 and the negative lens L12 are cemented. The fourth lens unit G4 includes a positive lens L13, a negative lens L14, a positive lens L15, and a negative lens L16. The positive lens L15 and the negative lens L16 are cemented. Aspherical surfaces are used for both surfaces of the negative lens L14. The lenses and the values corresponding to the respective conditional expressions are as indicated in Table 1.

### EXAMPLE 3

The structure of the zoom lens of Example 3 is described. The zoom lens of Example 3 includes the first lens unit G1 having a positive refractive power, the second lens unit G2 having a negative refractive power, the aperture stop STOP that determines a predetermined aperture, and the third lens unit G3 having a positive refractive power. The optical block CG is arranged between the third lens unit G3 and the image plane IMG. If this optical block CG is not necessary, the optical block CG can be omitted.

The first lens unit G1 includes a negative lens L1, a positive lens L2, a negative lens L3, a positive lens L4, and a positive lens L5. The negative lens L1 and the positive lens L2 are cemented, and the negative lens L3 and the positive lens L4 are cemented. The second lens unit G2 includes a negative lens L6, a negative lens L7, a positive lens L8, a negative lens L9, and a positive lens L10. The negative lens L7 and the positive lens L8 are cemented, and the negative lens L9 and the positive lens L10 are cemented. Aspherical surfaces are used for both surfaces of the negative lens L6.

The third lens unit G3 includes a positive lens L11, a positive lens L12, a negative lens L13, a positive lens L14, a negative lens L15, a positive lens L16, and a negative lens L17. The positive lens L12 and the negative lens L13 are cemented, and the positive lens L16 and the negative lens L17 are cemented. Aspherical surfaces are used for both surfaces of the negative lens L15.

During zooming, the second lens unit G2 and the third lens unit G3 are configured to move in the optical axis direction. Specifically, when the second lens unit G2 is moved along the optical axis, the magnification is varied, and a variation in the image plane associated therewith is corrected by moving the third lens unit G3. The lenses and the values corresponding to the respective conditional expressions are as indicated in Table 1.

### EXAMPLE 4

The structure of the zoom lens of Example 4 is described. The zoom lens of Example 4 includes the first lens unit G1 having a positive refractive power, the second lens unit G2 having a negative refractive power, the aperture stop STOP that determines a predetermined aperture, the third lens unit G3 having a positive refractive power, the fourth lens unit G4 having a positive refractive power, and the fifth lens unit G5 having a positive refractive power. The optical block CG is arranged between the fifth lens unit G5 and the image plane IMG. If this optical block CG is not necessary, the optical block CG can be omitted.

The first lens unit G1 includes a negative lens L1, a positive lens L2, a negative lens L3, a positive lens L4, and a positive lens L5. The negative lens L1 and the positive lens L2 are cemented, and the negative lens L3 and the positive lens L4 are cemented. The second lens unit G2 includes a negative lens L6, a negative lens L7, a positive lens L8, a negative lens L9, and a positive lens L10. The negative lens L7 and the positive lens L8 are cemented, and the negative lens L9 and the positive lens L10 are cemented. Aspherical surfaces are used for both surfaces of the negative lens L6.

The third lens unit G3 includes a positive lens L11, a positive lens L12, and a negative lens L13, and the positive lens L12 and the negative lens L13 are cemented. The fourth lens unit G4 includes a positive lens L14, a negative lens L15, a positive lens L16, and a negative lens L17, and the positive lens L16 and the negative lens L17 are cemented. Aspherical surfaces are used for both surfaces of the negative lens L15.

The fifth lens unit G5 includes a positive lens L18 and a negative lens L19, and the positive lens L18 and the negative lens L19 are cemented. During zooming, the second lens unit G2 and the fourth lens unit G4 are configured to move in the optical axis direction. Specifically, when the second lens unit G2 is moved along the optical axis, the magnification is varied, and a variation in the image plane associated therewith is corrected by moving the fourth lens unit G4. The lenses and the values corresponding to the respective conditional expressions are as indicated in Table 1.

Although the exemplary examples of the present invention have been described so far, the present invention is by no means limited to those examples, and hence various changes and modifications can be made within the scope of the subject matter of the present invention. For example, the zoom lens corrected for the chromatic aberration within a wavelength range from a wavelength of 400 nm to a wavelength of 1,700 nm has been described in the examples of the present invention, but the correction wavelength range is not limited, and the present invention can be similarly applied to a zoom lens with a narrower or broader correction wavelength range. In addition, the first lens unit G1 is configured not to move during zooming in each of the examples, but even when a configuration in which the first lens unit G1 is moved is adopted, the effect of the present invention can be obtained.

Now, numerical examples in the respective examples are shown. In each of the numerical examples, a surface number i is an optical surface counted in order from an object plane to an image plane. Symbol ri represents a curvature radius of the i-th optical surface. Symbol di represents an interval between the i-th optical surface and the (i+1)th optical surface (the positive sign is assigned when the interval is measured from the object side to the image plane side (when the light approaches), and the negative sign is assigned for the opposite direction). Symbols ndi and νdi represent the refractive index and the Abbe number of the material at a wavelength of 587.6 nm (d-line), respectively.

Specifically, the Abbe number νd is νd=(Nd−1)/(NF−Nc), where NF represents a refractive index of a material at a wavelength of 486 nm, Nd represents a refractive index of a material at a wavelength of 587.6 nm, and Nc represents a refractive index of a material at a wavelength of 656 nm. Further, two surfaces closest to the image side are planes corresponding to the optical block. The focal length is a value at a wavelength of 587.6 nm.

The aspherical shape is expressed through a general aspherical expression as in the following expression. In the following expression, symbol Z represents a coordinate in the optical axis direction, symbol c represents a curvature (inverse of curvature radius r), symbol h represents a height from the optical axis, symbol K represents a conic constant, and symbols A, B, C, D, and E represent fourth-order, sixth-order, eighth-order, tenth-order, and twelfth-order aspherical coefficients, respectively.

$$Z = \frac{{ch}^{2}}{1 + \sqrt{( 1 + K )} {c}^{2} {h}^{2}} + A {h}^{4} + {Bh}^{6} + {Ch}^{8} + {Dh}^{10} + {Eh}^{12}$$

Expression [E-X] means [10^{-x}]. Symbol * means a surface having an aspherical shape. In addition, a relationship between each of the conditional expressions described above and the numerical examples is shown in Table 1.

### NUMERICAL EXAMPLE 1

Surface data

| Surface number | r | d | nd | νd |
|---|---|---|---|---|
| 1 | 111.994 | 1.60 | 1.74100 | 52.64 |
| 2 | 33.301 | 10.43 | 1.43875 | 94.95 |
| 3 | −153.369 | 0.15 | | |
| 4 | 33.220 | 7.71 | 1.43875 | 94.95 |
| 5 | −1,683.989 | d5 | | |
| 6* | 128.907 | 0.75 | 1.88300 | 40.77 |
| 7* | 11.913 | 6.14 | | |
| 8 | −17.557 | 0.75 | 1.49700 | 81.55 |
| 9 | 19.515 | 3.34 | 1.80100 | 34.97 |
| 10 | −20.752 | 0.45 | | |
| 11 | −17.218 | 0.75 | 1.49700 | 81.55 |
| 12 | 8.937 | 2.50 | 1.64000 | 60.08 |
| 13 | 20.483 | d13 | | |
| 14 (Stop) | ∞ | 1.20 | | |
| 15 | 22.665 | 2.50 | 1.49700 | 81.55 |
| 16 | −16.537 | 0.50 | 1.73400 | 51.47 |
| 17 | −64.425 | d17 | | |
| 18 | 9.603 | 4.04 | 1.43875 | 94.95 |
| 19 | −40.219 | 2.00 | | |
| 20* | 45.979 | 2.83 | 1.58313 | 59.39 |
| 21* | 6.558 | 1.15 | | |
| 22 | 9.690 | 3.15 | 1.49700 | 81.55 |
| 23 | −7.591 | 0.60 | 1.80440 | 39.59 |
| 24 | −19.673 | d24 | | |
| 25 | ∞ | 10.00 | 1.51633 | 64.14 |
| 26 | ∞ | | | |

Aspherical surface data
Surface number

| | | | | |
|---|---|---|---|---|
| 6 | K = 0 | A = 2.45255E−04 | B = −6.58985E−07 | C = −2.72036E−09 |
| | D = 8.80648E−12 | E = 0 | | |
| 7 | K = 0 | A = 2.71432E−04 | B = 1.88056E−06 | C = 1.84125E−08 |
| | D = 1.72925E−10 | E = 0 | | |
| 20 | K = 0 | A = −5.28483E−04 | B = 5.91269E−06 | C = −6.80903E−08 |
| | D = 2.73739E−10 | E = 0 | | |
| 21 | K = 0 | A = −7.05797E−04 | B = 3.81508E−06 | C = 2.60374E−08 |
| | D = −6.63828E−09 | E = 0 | | |

Various data

| | Wide angle | | Telephoto |
|---|---|---|---|
| | end | Intermediate | end |
| Focal length | 4.80 | 21.37 | 95.03 |
| Fno | 1.80 | 3.00 | 3.50 |
| Image height | 3.0 | 3.0 | 3.0 |
| d5 | 0.15 | 29.97 | 46.28 |
| d13 | 46.69 | 16.87 | 0.56 |
| d17 | 11.14 | 4.72 | 0.15 |
| d24 | 0.51 | 6.94 | 11.51 |

### NUMERICAL EXAMPLE 2

Surface data

| Surface number | r | d | nd | νd |
|---|---|---|---|---|
| 1 | 85.678 | 1.60 | 1.77250 | 49.60 |
| 2 | 53.673 | 7.42 | 1.43875 | 94.95 |
| 3 | −256.061 | 0.15 | | |
| 4 | 107.169 | 1.00 | 1.74100 | 52.64 |
| 5 | 33.843 | 7.04 | 1.49700 | 81.55 |
| 6 | 383.092 | 0.15 | | |
| 7 | 34.409 | 5.72 | 1.49700 | 81.55 |
| 8 | 177.441 | d8 | | |
| 9* | 38.722 | 0.75 | 1.85400 | 40.39 |
| 10* | 7.885 | 5.90 | | |
| 11 | −13.046 | 0.75 | 1.49700 | 81.55 |
| 12 | 18.773 | 2.89 | 1.80100 | 34.97 |
| 13 | −18.983 | 0.35 | | |
| 14 | −16.337 | 0.75 | 1.49700 | 81.55 |
| 15 | 10.677 | 2.03 | 1.64000 | 60.08 |
| 16 | 36.738 | d16 | | |
| 17 (Stop) | ∞ | 1.20 | | |
| 18 | 25.390 | 3.50 | 1.61272 | 58.72 |
| 19 | −9.931 | 0.50 | 1.61336 | 44.49 |
| 20 | 442.094 | d20 | | |
| 21 | 7.836 | 3.99 | 1.43875 | 94.95 |
| 22 | −43.218 | 1.64 | | |
| 23* | −44.728 | 2.83 | 1.58313 | 59.39 |
| 24* | 7.629 | 1.15 | | |
| 25 | 11.910 | 5.00 | 1.49700 | 81.55 |
| 26 | −5.369 | 0.60 | 1.75700 | 47.82 |
| 27 | −12.631 | d27 | | |
| 28 | ∞ | 7.00 | 1.51633 | 64.14 |
| 29 | ∞ | | | |

Aspherical surface data
Surface number

| | | | | |
|---|---|---|---|---|
| 9 | K = 0 | A = 1.76316E−04 | B = −1.44422E−06 | C = 6.10652E−09 |
| | D = −1.75125E−11 | E = 0 | | |
| 10 | K = 0 | A = 1.48195E−04 | B = 1.88488E−07 | C = 2.57337E−08 |
| | D = −5.58580E−11 | E = 0 | | |
| 23 | K = 0 | A = −6.68556E−04 | B = 1.30440E−05 | C = −1.25343E−07 |
| | D = 4.77965E−10 | E = 0 | | |
| 24 | K = 0 | A = −6.55190E−04 | B = 1.05759E−05 | C = 1.14282E−07 |
| | D = −8.57518E−09 | E = 0 | | |

Various data

| | Wide angle | | Telephoto |
|---|---|---|---|
| | end | Intermediate | end |
| Focal length | 4.80 | 21.35 | 95.00 |
| Fno | 1.80 | 3.00 | 3.50 |
| Image height | 3.0 | 3.0 | 3.0 |
| d8 | 0.33 | 29.11 | 44.42 |
| d16 | 44.45 | 15.67 | 0.36 |
| d20 | 11.93 | 5.11 | 0.78 |
| d27 | 0.70 | 7.52 | 11.85 |

### NUMERICAL EXAMPLE 3

Surface data

| Surface number | r | d | nd | νd |
|---|---|---|---|---|
| 1 | 60.093 | 1.60 | 1.74100 | 52.64 |
| 2 | 42.975 | 9.58 | 1.43875 | 94.95 |
| 3 | −161.059 | 0.15 | | |
| 4 | 52.582 | 1.00 | 1.74100 | 52.64 |
| 5 | 22.988 | 7.56 | 1.49700 | 81.55 |
| 6 | 103.224 | 0.15 | | |
| 7 | 23.145 | 5.19 | 1.49700 | 81.55 |
| 8 | 36.981 | d8 | | |
| 9* | 23.491 | 0.75 | 1.85400 | 40.39 |
| 10* | 8.025 | 7.37 | | |
| 11 | −16.143 | 0.75 | 1.49700 | 81.55 |
| 12 | 14.244 | 3.25 | 1.80100 | 34.97 |
| 13 | −29.899 | 1.89 | | |
| 14 | −10.801 | 0.75 | 1.49700 | 81.55 |
| 15 | 18.221 | 1.98 | 1.64000 | 60.08 |
| 16 | −464.540 | d16 | | |
| 17 (Stop) | ∞ | d17 | | |
| 18 | 21.709 | 3.00 | 1.61800 | 63.33 |
| 19 | 77.283 | 0.52 | | |
| 20 | 20.087 | 5.25 | 1.49700 | 81.55 |
| 21 | −13.635 | 0.50 | 1.58313 | 59.37 |
| 22 | 20.746 | 0.15 | | |
| 23 | 11.668 | 5.42 | 1.43875 | 94.95 |
| 24 | −21.485 | 0.55 | | |
| 25* | 46.298 | 2.83 | 1.58313 | 59.39 |
| 26* | 7.435 | 1.16 | | |
| 27 | 11.656 | 3.82 | 1.49700 | 81.55 |
| 28 | −11.831 | 0.60 | 1.83400 | 37.16 |
| 29 | −24.305 | d29 | | |
| 30 | ∞ | 10.00 | 1.51633 | 64.14 |
| 31 | ∞ | | | |

Aspherical surface data
Surface number

| | | | | |
|---|---|---|---|---|
| 9 | K = 0 | A = 2.10121E−04 | B = −5.70504E−06 | C = 9.65937E−08 |
| | D = −7.37412E−10 | E = 2.26893E−12 | | |
| 10 | K = 0 | A = 1.56200E−04 | B = −5.41604E−06 | C = −2.37304E−08 |
| | D = 2.17662E−09 | E = −1.88149E−11 | | |
| 25 | K = 0 | A = −5.05854E−04 | B = 4.49281E−06 | C = −2.35170E−08 |
| | D = 5.39792E−11 | E = −2.91340E−12 | | |
| 26 | K = 0 | A = −6.45443E−04 | B = 6.30637E−06 | C = −1.67746E−07 |
| | D = 4.22257E−09 | E = −8.31116E−11 | | |

Various data

| | Wide angle | | Telephoto |
|---|---|---|---|
| | end | Intermediate | end |
| Focal length | 6.50 | 24.85 | 95.00 |
| Fno | 2.00 | 2.50 | 3.50 |
| Image height | 3.0 | 3.0 | 3.0 |
| d8 | 0.17 | 20.34 | 31.36 |
| d16 | 33.66 | 13.49 | 2.47 |
| d17 | 13.62 | 7.31 | 0.15 |
| d29 | 2.82 | 9.12 | 16.29 |

### NUMERICAL EXAMPLE 4

Surface data

| Surface number | r | d | nd | νd |
|---|---|---|---|---|
| 1 | 75.623 | 1.60 | 1.77250 | 49.60 |
| 2 | 44.999 | 8.98 | 1.43875 | 94.95 |
| 3 | −372.998 | 0.15 | | |
| 4 | 121.274 | 1.00 | 1.74100 | 52.64 |
| 5 | 40.587 | 6.96 | 1.49700 | 81.55 |
| 6 | 580.269 | 0.15 | | |
| 7 | 35.458 | 6.53 | 1.49700 | 81.55 |
| 8 | 151.599 | d8 | | |
| 9* | 55.283 | 0.75 | 1.85135 | 40.10 |
| 10* | 8.330 | 5.97 | | |
| 11 | −12.883 | 0.75 | 1.49700 | 81.55 |
| 12 | 18.440 | 3.61 | 1.80440 | 39.59 |
| 13 | −14.118 | 0.49 | | |
| 14 | −12.073 | 0.75 | 1.49700 | 81.55 |
| 15 | 10.302 | 1.93 | 1.65100 | 56.16 |
| 16 | 27.912 | d16 | | |
| 17 (Stop) | ∞ | 1.20 | | |
| 18 | 23.496 | 3.00 | 1.61800 | 63.33 |
| 19 | −348.913 | 0.15 | | |
| 20 | 19.699 | 2.24 | 1.49700 | 81.55 |
| 21 | −21.706 | 0.50 | 1.57250 | 57.74 |
| 22 | 15.492 | d22 | | |
| 23 | 9.984 | 5.84 | 1.43875 | 94.95 |
| 24 | −25.914 | 0.26 | | |
| 25* | 130.827 | 2.83 | 1.58313 | 59.39 |
| 26* | 7.855 | 1.00 | | |
| 27 | 10.282 | 6.00 | 1.49700 | 81.55 |
| 28 | −9.472 | 1.00 | 1.80440 | 39.59 |
| 29 | −24.450 | d29 | | |
| 30 | −67.419 | 4.00 | 1.51633 | 64.14 |
| 31 | −12.501 | 1.50 | 1.74100 | 52.64 |
| 32 | −23.706 | 0.24 | | |
| 33 | ∞ | 5.00 | 1.51633 | 64.14 |
| 34 | ∞ | | | |

Aspherical surface data
Surface number

| | | | | |
|---|---|---|---|---|
| 9 | K = 0 | A = 8.47539E−05 | B = −2.40879E−07 | C = −3.33363E−09 |
| | D = 2.37069E−11 | E = 0 | | |
| 10 | K = 0 | A = 4.52940E−05 | B = 6.95688E−07 | C = 7.10252E−09 |
| | D = −2.20545E−10 | E = 0 | | |
| 25 | K = 0 | A = −3.62742E−04 | B = 3.28515E−06 | C = −2.05525E−08 |
| | D = −2.63194E−11 | E = 0 | | |
| 26 | K = 0 | A = −3.80603E−04 | B = 3.32475E−06 | C = 8.56955E−09 |
| | D = −5.77114E−10 | E = 0 | | |

Various data

| | Wide angle | | Telephoto |
|---|---|---|---|
| | end | Intermediate | end |
| Focal length | 4.80 | 24.00 | 119.99 |
| Fno | 1.80 | 3.00 | 3.50 |
| Image height | 3.0 | 3.0 | 3.0 |
| d8 | 0.15 | 31.22 | 46.70 |
| d16 | 47.09 | 16.02 | 0.53 |
| d22 | 14.05 | 5.91 | 0.15 |
| d29 | 0.49 | 8.63 | 14.39 |

TABLE 1

| Conditional Expression | | | Example 1 | | Example 2 | | Example 3 | | Example 4 | |
|---|---|---|---|---|---|---|---|---|---|---|
| (1) | Lens Pair LB1 | LP1 | L2 | −0.00052 | L2 | −0.00165 | L2 | −0.00052 | L2 | −0.00165 |
| | | LN1 | L1 | | L1 | | L1 | | L1 | |
| | | LP1 | | | L4 | 0.00009 | L4 | 0.00009 | L4 | 0.00009 |
| | | LN1 | | | L3 | | L3 | | L3 | |
| (2) | Positive Lenses | vIRP1a | L2 | 24.78 | L2 | 24.78 | L2 | 24.78 | L2 | 24.78 |
| | in First Lens | | L3 | 24.78 | L4 | 21.45 | L4 | 21.45 | L4 | 21.45 |
| | Unit G1 | | | | L5 | 21.45 | L5 | 21.45 | L5 | 21.45 |
| (3) | Lens Pair LB2 | LP2 | L6 | | L8 | | L8 | | L8 | |
| | | LN2 | L5 | −0.00459 | L7 | −0.00459 | L7 | −0.00459 | L7 | −0.00426 |
| | | LP2 | L8 | | L10 | | L10 | | L10 | |
| | | LN2 | L7 | 0.00498 | L9 | 0.00498 | L9 | 0.00498 | L9 | −0.00126 |

| | | | | | |
|---|---|---|---|---|---|
| (4) | (F1L-F1M)/F1M | 0.00197 | 0.00253 | 0.00144 | 0.00216 |
| (5) | F1M/FTM | 0.75 | 0.74 | 0.68 | 0.61 |

Next, an example of a monitoring camera (image pickup apparatus) including the zoom lens of the present invention as an image pickup optical system is described with reference to FIG. 9. In FIG. 9, a monitoring camera main body 30 and an image pickup optical system 31 constructed with the zoom lens described in any one of Examples 1 to 4 are illustrated. A solid-state image pickup element 32 (photo-electric conversion element), such as a CCD sensor and a CMOS sensor, is embedded in the camera main body and receives light of a subject image formed by the image pickup optical system 31.

A memory 33 records information corresponding to the subject image subjected to photoelectric conversion by the solid-state image pickup element 32. A network cable 34 is used to transfer the captured subject image subjected to photoelectric conversion by the solid-state image pickup element 32.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-237550, filed Nov. 25, 2014, which is hereby incorporated by reference herein in its entirety.

What is claimed is:

1. A zoom lens, comprising, in order from an object side to an image side:
a first lens unit having a positive refractive power;
a second lens unit having a negative refractive power; and
a third lens unit having a positive refractive power,
wherein the second lens unit is configured to move toward the image side during zooming from a wide angle end to a telephoto end, and an interval between adjacent lens units is changed during zooming,
wherein the first lens unit comprises a positive lens (LP1) and a negative lens (LN1) that are arranged adjacent to each other, and
wherein the following conditional expression is satisfied:
−0.003<(θIRP1−θIRN1)/(νIRP1−νIRN1)<0.003
where, when a refractive index of a lens material at a wavelength of 400 nm is Ns, a refractive index of a lens material at a wavelength of 1,050 nm is Nm, a refractive index of a lens material at a wavelength of 1,700 nm is Nl, and an Abbe number νIR of a lens material and a partial dispersion ratio θIR of a lens material are νIR=(Nm−1)/(Ns−Nl) and θIR=(Ns−Nm)/(Ns−Nl), respectively, νIRP1 and θIRP1 represent an Abbe number and a partial dispersion ratio of a material for the positive lens (LP1), respectively, and νIRN1 and θIRN1 represent an Abbe number and a partial dispersion ratio of a material for the negative lens (LN1), respectively.

2. A zoom lens according to claim 1, wherein the following conditional expression is satisfied:
18.0<νIRP1a
where νIRP1a represents an Abbe number of a material for a positive lens included in the first lens unit.

3. A zoom lens according to claim 1,
wherein the second lens unit comprises a positive lens (LP2) and a negative lens (LN2) that are arranged adjacent to each other, and
wherein the following conditional expression is satisfied:
−0.005<(θIRP2−θIRN2)/(νIRP2−νIRN2)<0.005
where νIRP2 and θIRP2 represent an Abbe number and a partial dispersion ratio of a material for the positive lens (LP2), respectively, and νIRN2 and θIRN2 represent an Abbe number and a partial dispersion ratio of a material for the negative lens (LN2), respectively.

4. A zoom lens according to claim 3, wherein the positive lens (LP2) and the negative lens (LN2) are cemented.

5. A zoom lens according to claim 1, wherein the positive lens (LP1) and the negative lens (LN1) are cemented.

6. A zoom lens according to claim 1, wherein the following conditional expression is satisfied:
0.50<F1M/FTM<1.00
where F1M represents a focal length of the first lens unit at a wavelength of 1,050 nm, and FTM represents a focal length of the zoom lens at a wavelength of 1,050 nm at the telephoto end.

7. A zoom lens according to claim 1,
wherein the zoom lens consists of, in order from an object side to an image side, a first lens unit having a positive refractive power, a second lens unit having a negative refractive power, and a third lens unit having a positive refractive power, and
wherein the third lens unit is configured to move toward the object side during zooming from a wide angle end to a telephoto end.

8. A zoom lens according to claim 1,
wherein the zoom lens consists of, in order from an object side to an image side, a first lens unit having a positive refractive power, a second lens unit having a negative refractive power, a third lens unit having a positive refractive power, and a fourth lens unit having a positive refractive power, and
wherein the fourth lens unit is configured to move toward the object side during zooming from a wide angle end to a telephoto end.

9. A zoom lens according to claim 1,
wherein the zoom lens consists of, in order from an object side to an image side, a first lens unit having a positive refractive power, a second lens unit having a negative refractive power, a third lens unit having a positive refractive power, a fourth lens unit having a positive refractive power, and a fifth lens unit having a positive refractive power, and
wherein the fourth lens unit is configured to move toward the object side during zooming from a wide angle end to a telephoto end.

10. A zoom lens according to claim 1, wherein the following conditional expression is satisfied:
−0.005<(F1L−F1M)/F1M<0.005
where F1M represents a focal length of the first lens unit at a wavelength of 1,050 nm, and F1L represents a focal length of the first lens unit at a wavelength of 1,700 nm.

11. A zoom lens, comprising, in order from an object side to an image side:
a first lens unit having a positive refractive power;
a second lens unit having a negative refractive power; and
a third lens unit having a positive refractive power,
wherein the second lens unit is configured to move toward the image side during zooming from a wide angle end to a telephoto end, and an interval between adjacent lens units is changed during zooming,
wherein the following conditional expression is satisfied:
−0.005<(F1L−F1M)/F1M<0.005
where F1M represents a focal length of the first lens unit at a wavelength of 1,050 nm, and F1L represents a focal length of the first lens unit at a wavelength of 1,700 nm.

12. A zoom lens according to claim 11, wherein the following conditional expression is satisfied:
0.50<F1M/FTM<1.00
where F1M represents a focal length of the first lens unit at a wavelength of 1,050 nm, and FTM represents a focal length of the zoom lens at a wavelength of 1,050 nm at the telephoto end.

13. A zoom lens according to claim 11,
wherein the zoom lens consists of, in order from an object side to an image side, a first lens unit having a positive refractive power, a second lens unit having a negative refractive power, and a third lens unit having a positive refractive power, and
wherein the third lens unit is configured to move toward the object side during zooming from a wide angle end to a telephoto end.

14. A zoom lens according to claim 11,
wherein the zoom lens consists of, in order from an object side to an image side, a first lens unit having a positive refractive power, a second lens unit having a negative refractive power, a third lens unit having a positive refractive power, and a fourth lens unit having a positive refractive power, and
wherein the fourth lens unit is configured to move toward the object side during zooming from a wide angle end to a telephoto end.

15. A zoom lens according to claim 11,
wherein the zoom lens consists of, in order from an object side to an image side, a first lens unit having a positive refractive power, a second lens unit having a negative refractive power, a third lens unit having a positive refractive power, a fourth lens unit having a positive refractive power, and a fifth lens unit having a positive refractive power, and
wherein the fourth lens unit is configured to move toward the object side during zooming from a wide angle end to a telephoto end.

16. An image pickup apparatus, comprising:
a zoom lens; and
a solid-state image pickup element configured to receive light of an image formed by the zoom lens,
the zoom lens comprising, in order from an object side to an image side:
a first lens unit having a positive refractive power;
a second lens unit having a negative refractive power; and
a third lens unit having a positive refractive power,
the second lens unit being configured to move toward the image side during zooming from a wide angle end to a telephoto end, an interval between adjacent lens units being changed during zooming,
the first lens unit comprising a positive lens (LP1) and a negative lens (LN1) that are arranged adjacent to each other,
the following conditional expression being satisfied:
−0.003<(θIRP1−θIRN1)/(νIRP1−νIRN1)<0.003
where, when a refractive index of a lens material at a wavelength of 400 nm is Ns, a refractive index of a lens material at a wavelength of 1,050 nm is Nm, a refractive index of a lens material at a wavelength of 1,700 nm is Nl, an Abbe number νIR of a lens material and a partial dispersion ratio θIR of a lens material are νIR=(Nm−1)/(Ns−Nl) and θIR=(Ns−Nm)/(Ns−Nl), respectively, νIRP1 and θIRP1 represent an Abbe number and a partial dispersion ratio of a material for the positive lens (LP1), respectively, and νIRN1 and θIRN1 represent an Abbe number and a partial dispersion ratio of a material for the negative lens (LN1), respectively.

17. An image pickup apparatus, comprising:
a zoom lens; and
a solid-state image pickup element configured to receive light of an image formed by the zoom lens,
the zoom lens comprising, in order from an object side to an image side:
a first lens unit having a positive refractive power;
a second lens unit having a negative refractive power; and
a third lens unit having a positive refractive power,
the second lens unit being configured to move toward the image side during zooming from a wide angle end to a telephoto end, an interval between adjacent lens units being changed during zooming,
the following conditional expression being satisfied:
−0.005<(F1L−F1M)/F1M<0.005
where F1M represents a focal length of the first lens unit at a wavelength of 1,050 nm, and F1L represents a focal length of the first lens unit at a wavelength of 1,700 nm.
